(19) United States
(12) Patent Application Publication
(10) Pub. No.: US 2006/0215596 A1
(43) Pub. Date: Sep. 28, 2006

(54) Network aware cross-layer protocol methods and apparatus

(75) Inventors: Dilip Krishnaswamy, Roseville, CA (US); Mousumi Hazra, Beaverton, OR (US); Hsin-Yuo Liu, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 11/087,257

(22) Filed: Mar. 23, 2005

(51) Int. Cl. H04J 3/14; H04J 1/16; H04L 1/00; H04J 3/22; H04J 3/16; H04Q 7/00; H04L 12/26

(52) U.S. Cl. 370/328; 370/465; 370/252

(57) ABSTRACT

Methods and apparatus provide transfer rate adjustments for a device, which in an embodiment comprises a multimedia server. These rate adjustments are based upon determining by the multimedia server various quality of service parameters from a wireless link between two other network nodes, which may comprise an access point and a video player, respectively.

### BACKGROUND

The present subject matter pertains to communication systems and, more particularly, to wireless data communication systems.

Streaming multimedia services over wireless local area networks pose many challenges in providing media data, including bandwidth variations, data losses and non-uniformity of the receivers. Currently each network layer provides a separate solution to these challenges by providing its own optimized adaptation and protection mechanisms. However, a layered strategy does not always result in optimal overall performance for the transmission of multimedia.

Certain protection strategies may be implemented simultaneously in several layers. Therefore, the optimal choices from the application and complexity perspective may be difficult to ascertain. However, a layered strategy does not always result in an optimal overall performance for the transmission of multimedia signals.

Transmitting multimedia signals over wireless networks has several constraints such as interference, competing traffic, bandwidth variations, multi-path fading, partial data loss, device scalability in terms of data rates, and power requirements. These constraints need to be addressed in order to provide reliable and efficient multimedia transmission.

Typically, traffic is monitored in computing platforms relative only to the platform itself. Computing platforms, however, do not actively monitor additional traffic. That is, data packets that are arriving at or leaving from the other nodes within a network are not monitored for traffic considerations.

### BRIEF DESCRIPTION OF THE DRAWINGS

FIG. 1 is a block diagram of a telecommunication system in accordance with an embodiment of the present invention.

FIG. 2 is a block diagram of a telecommunication system in accordance with another embodiment of the present invention.

FIG. 3 is a block diagram of a multimedia server in accordance with various embodiments of the present invention.

FIG. 4 is a flow chart of a method for telecommunication data transfer in accordance with various embodiments of the present invention.

FIG. 5 is a flow chart depicting obtaining data from other telecommunication system nodes in accordance with various embodiments of the present invention.

FIG. 6 is a flow chart depicting obtaining bandwidth estimations from other system nodes in accordance with various embodiments of the present invention.

FIG. 7 is a flow chart depicting trans-rating data in accordance with various embodiments of the present invention.

FIG. 8 is a flow chart of an alternate link selection method in accordance with various embodiments of the present invention.

### DETAILED DESCRIPTION

FIG. 1 is a block diagram of a telecommunication system in accordance with an embodiment of the present invention. FIG. 1 depicts multimedia server 10 coupled via wire line interface 11 to access point (AP) or network node 20. Multimedia server 10 may comprise a streaming video server such as those made by Intel Corporation or others.

Access point 20 may be coupled to video server 10 via a wire line coupling 11 or wirelessly as will be shown infra. An access point (AP) is a hardware device and/or computer software that acts as a communication hub for users of wireless devices to connect these wireless devices to a local area network. Access points are important for providing heightened wireless security and for extending the physical range of service of a wireless user. An access point may include any such device compliant with IEEE 802.11 Standards (Institute of Electrical and Electronics Engineers, Section 802.11, published 1998). These access points may commonly be provided by manufacturers such as Linksys, US Robotics, NetGear and many other manufacturers.

Network node or AP 20 is coupled to multimedia node 30 via a wireless link 21. Signals transmitted by the multimedia node 30 may include any type of high speed node and any type of high speed wide band data signals. An example of a multimedia node is a video node that may receive video signals that may be presented on a television and, by video adapting these signals, is able to present them on a computer monitor or other suitable display device. These video signals may be originally obtained from a video recorder or camcorder or another device that captures full motion on video. The video node may include a video player. Examples of video players include, but are not limited to, a Network Media Player (NMP-4000) provided by icube Corporation, and a Dual Band Wireless A/G Media Center extender (WMCE54AG) provided by Linksys, a division of Cisco Systems, Inc.

Multimedia server 10 may also have an antenna 15. Antenna 15 couples multimedia server 10 wirelessly to the wireless link 21. Wireless link 21 couples network node or AP 20 via wireless link 21 to multimedia node 30. Multimedia server 10 couples to wireless link 21 via wireless link 13 in order to monitor traffic or data packets between AP 20 and multimedia node 30. This monitoring of traffic or data packets is referred to as “sniffing”. Antenna 15 may optionally couple multimedia server 10 wirelessly to the wireless link 31. Wireless link 31 may couple multimedia server 10 to multimedia node 30 via a peer-to-peer wireless connection 31.

Antenna 15 may be a directional or omni-directional antenna, including, for example, a dipole antenna, a monopole antenna, a patch antenna, a loop antenna, a microstrip antenna, or various other types of antennas suitable for transmission and/or reception of data packet signals.

Multimedia server 10 is able to “sniff” the data packet stream on wireless link 21, via antenna 15 and wireless link 13. A data packet “sniffer” is a device designed for the purpose of monitoring wireless data packets or traffic in order to recognize and decode certain data packets of interest. Data packet sniffers are similar in theory to telephone wire taps. Data packet sniffing, however, has an advantage in that it may be performed from almost any network connection. Such action is commonly termed sniffing in a “promiscuous mode.”

As a result, multimedia server 10 sniffs and monitors the data packets on wireless link 21. Multimedia server 10 is able to gather quality of service information and parameters. With these parameters and quality of service information, multimedia server 10 may adjust or trans-rate the rate at which information is sent to the AP 20 on wireline 11.

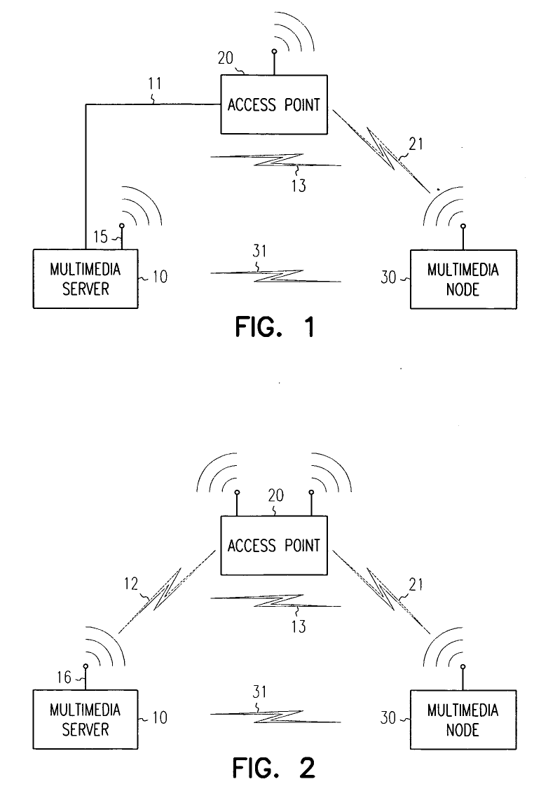

FIG. 2 is a block diagram of a telecommunication system depicting another embodiment of the present invention. Multimedia server 10 may be the same as described above in FIG. 1. However, multimedia server 10 is now coupled via antenna 16 to access point 20 via wireless connection 12. FIG. 2 depicts antenna 16 being coupled to wireless link 21 via wireless link 13.

Antenna 16 may be similar to antenna 15. Antenna 16 may provide wireless link 13 that enables multimedia server 10 to promiscuously sniff wireless link 21. In addition, antenna 16 is shown as providing the wireless communication link 12 that couples multimedia server 10 to access point 20. Antenna 16 may comprise separate antennas (not shown) for providing each of the wireless communication links 12 and 13. Antenna 16 may optionally couple multimedia server 10 wirelessly to the wireless link 31. Wireless link 31 couples multimedia server 10 to multimedia node 30 via a peer-to-peer wireless connection 31.

Antenna 16 may be a directional or omni-directional antenna, including, for example, a dipole antenna, a monopole antenna, a patch antenna, a loop antenna, a microstrip antenna, or various other types of antennas suitable for transmission and/or reception of data packet signals.

Access point 20 provides wireless communications with multimedia node 30 and also with multimedia server 10. The operation of multimedia server 10 in FIG. 2 may be similar to the operation of multimedia server 10 in FIG. 1, except that the function of transmitting streaming multimedia data on wireline 11 is performed by wireless communication link 12. The transmission of streaming multimedia signals is performed over wireless link 12 through access point 20 to multimedia node 30. As mentioned above, these multimedia signals may include full motion video, such as that provided by a camcorder, etc.

The data transfer rates of wireless link 12 of FIG. 2 and wire line link 11 of FIG. 1 control the operation and data transfer rate of wireless link 21 that is providing the multimedia signals of server 10 to multimedia node 30. In each embodiment of the present invention, multimedia server 10 attempts to trans-rate the data packets it is sending on links 11 and 12, respectively, based upon its observation via link 13 of the signal transfer rate between access point 20 and multimedia node 30 on link 21.

The telecommunication systems of FIGS. 1 and 2 provide for video trans-rating or adjusting the transmission rate of video signals on a link of a server to another network node such as an access point 20 based on quality of service information of another wireless link. This quality of service information may be directly measured by the video server 10 via wireless link 13. The quality of service information is measured on the wireless link 21 between the network node 20 and the video node 30. Further, when bandwidth is available on wireless link 21, video server 10 increases its data packet transmission rate. Also, if less bandwidth is available due to interference from noise on link 21, for example, video server may decrease its data packet transmission rate. By the trans-rating of server 10, the buffers of access point 20 may not be overflowed or emptied. As a result, a high data transfer rate may be maintained between server 10 and video node 30.

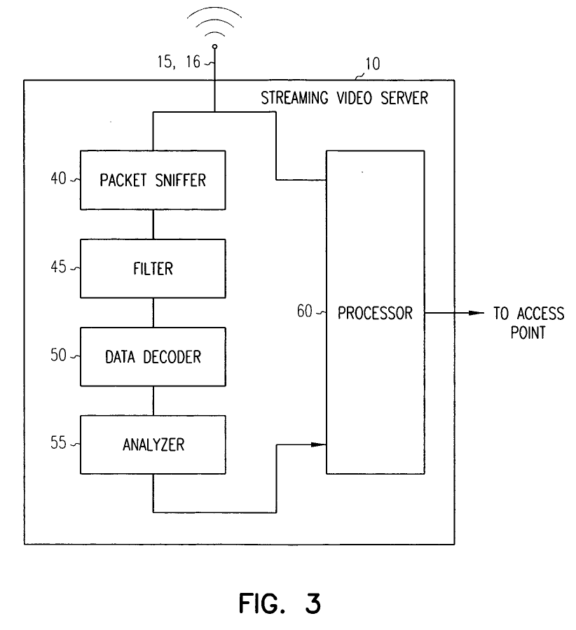

FIG. 3 is a block diagram of multimedia server 10 in accordance with various embodiments of the present invention. Streaming multimedia server or multimedia server or server 10 of FIGS. 1 and 2 is shown in detail.

Either antenna 15 of FIG. 1 or antenna 16 of FIG. 2 provides input via wireless link 13 to packet sniffer 40. Packet sniffer 40 is a device for monitoring wireless network traffic in order to recognize and decode certain data packets of interest. “Sniffers” are typically termed packet sniffers when they operate on networks that transmit protocol based data packets. Generally, MAC (media access control) protocol enables two hosts to establish a connection and exchange streams of data. This guarantees delivery of data and also guarantees that the packets are delivered in the same order in which they were sent.

Packet sniffer 40 thereby obtains all data packets transmitted from or by the network node or access point 20. The data packets of link 21 will be captured as well as the data packets of any other wireless links (not shown), which access point 20 may transmit to or receive from. The packet sniffer 40 then passes the data packets on to filter 45.

Filter 45 may be implemented in hardware or software to decode all of the packets received so as to obtain packets transmitted on wireless link 21. That is, filter 45 obtains those data packets transmitted on link 21 between access point 20 and multimedia player 30, while discarding all other data packets. Some of the information gathered relating to wireless link 21 is shown in TABLE I below.

TABLE I

| | | |
|---|---|---|
| Packet From | Extract from packet header | AP's MAC address |
| Packet To | Extract from packet header | MN's MAC address |
| # of Packets sent | Maintain a count | N |
| Sum packet size | Maintain a sum of packet | S_{N} |
| (bytes over time T) | size | |
| # of retransmitted | Count number of packets | R |
| packets (in time T) | with same SN seen | |
| # of lost packets | Count number of packets | N₁ |
| (in time T) | that were retransmitted | |
| | retransmission maximum | |
| | number of times | |
| Sum retransmitted | For packets with same SN, | Sᵣ |
| packet size | maintain sum of these | |
| (in time T) | packet sizes | |
| Estimated throughput | Calculate every T time | (S_{N} − Sᵣ)/T |
| | interval; reset stats after | |
| | time T | |
| Packet loss rate | Estimate using N and N₁ | N₁/N |

In Table I above, “AP” indicates access point 20. “MN” indicates multimedia node 30. “MAC” indicates media access control.

The data packets obtained from link 21 are then sent to data decoder 50. Data decoder 50 may be implemented in hardware or software that executes on processor 60. Data decoder 50 begins to obtain quality of service parameters such as data rate of the data packets, length of the data packets, and number of retransmissions of data packets. See TABLE I. Such quality of service parameters are transmitted by data decoder 50 to analyzer 55. Analyzer 55 may also be implemented in hardware or software that executes as machine accessible and readable instructions on processor 60 or an embedded processor (not shown). Analyzer 55 may estimate the bandwidth and/or retransmission counts of link 21 using the quality of surface information.

Packet sniffer 40, filter 45, data decoder 50 and analyzer 55 may be implemented on a chip or chip set. A chip is a semiconductor device. The semiconductor chip or chip set may be implemented as part of a wireless device or server 10. Server 10 may be implemented on a semiconductor chip or chip set. Further, packet sniffer 40, filter 45, data decoder 50, analyzer 55 and processor 60 or an embedded processor (not shown) may be implemented on a portion of a network interface card (NIC) inserted into a circuit card slot.

With all the elements of the quality of service information as mentioned above, processor 60 may then trans-rate or adjust the rate of data packet transmission of server 10 based upon these statistics or quality of service information or parameters. This adjustment may be performed by direct access by wireline 11 (refer to FIG. 1) of processor 60 to access point 20 or through a wireless link 12 (refer to FIG. 2) via antenna 16 by processor 60. In either event, the data packet transmission rate of the link between multimedia server 10 and access point 20 is adjusted to avoid over-filling the buffers of access point 20 or under-filling these buffers and thereby wasting bandwidth.

It should be noted that the methods described hereinafter do not need to be executed in the order described, or in any particular order.

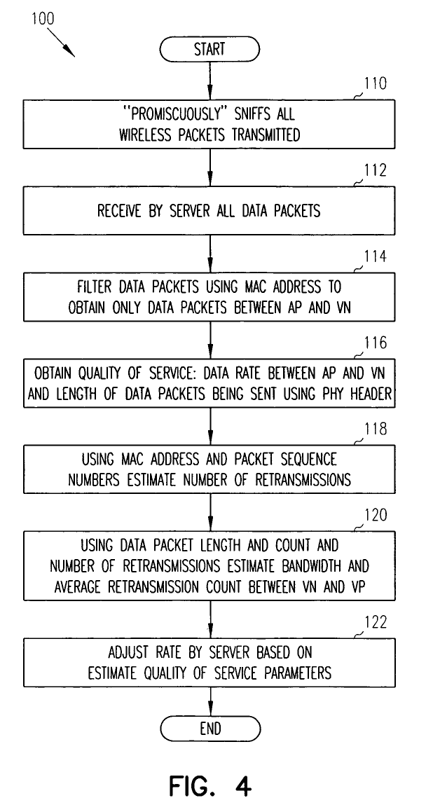

FIG. 4 is a flow chart of a method 100 for telecommunication data transfer in accordance with various embodiments of the present invention. The method 100 adjusts the data packet transmission rate between server 10 and access point 20 based upon the transmission rate on wireless link 21. The process is started and block 110 is entered. Packet sniffer 40 of multimedia server 10 “promiscuously sniffs” all wirelessly transmitted data packets. After sniffing wireless link 21 in the promiscuous mode, the obtained data packets are received by the server for processing by method 100, block 112.

The data packets are then filtered in block 114. This data packet filtering is done using the MAC (media access control) address. As a result, only data packets transmitted between access point 20 and multimedia node 30 are obtained by method 100, block 114.

In block 116, some of the quality of service parameters are obtained. These quality of service parameters may include the data rate between access point 20 and multimedia node 30 as an average of the data packets transmitted on wireless link 21. Further, the quality of service parameters may include an average length of data packets being sent on wireless link 21. The quality of service parameters may be obtained using the physical layer header (PHY) in which such information typically resides. Other quality of service parameters may be calculated as shown in the first column of TABLE I, such as throughput and loss rate, for example.

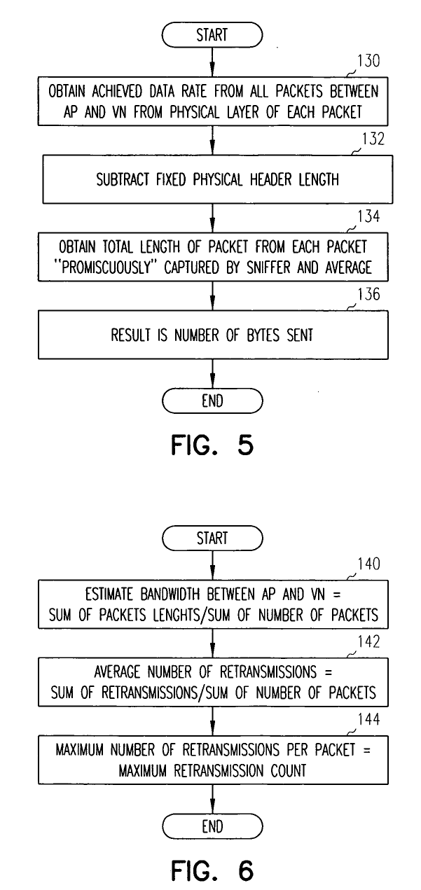

Blocks 118, 120, and 122 of FIG. 4 will be discussed below following a discussion of FIG. 5.

FIG. 5 is a flow chart depicting obtaining data from other telecommunication system nodes in accordance with various embodiments of the present invention. FIG. 5 depicts the methodology of block 116 of FIG. 4. In the physical layer header of each data packet on wireless link 21, an achieved data rate field is included. Block 130 obtains the achieved data rate of each data packet on link 21 from the physical layer header information of each packet and averages these achieved data rates.

The length and bytes of the physical header are fixed. Block 132 subtracts the length of the physical header from the total length determined. From each of the promiscuously sniffed data packets, block 132 obtains the total length of the data packet. The total lengths of each data packet are averaged by block 134.

Block 136 then provides the result. The total length is adjusted to be the length of the data of the data packet, block 136, since the MAC header has been subtracted out.

Returning again to FIG. 4, data decoder 50 makes an estimate of the number of data packet retransmissions on link 21 from the MAC address and the packet sequence numbers of the MAC header, block 118. The number of data packet retransmissions may be one measure of the quality of service of link 21.

Analyzer 55 uses the average data packet length and count of data packets along with the number of retransmissions determined by block 118 to estimate the bandwidth of wireless link 21, block 120. Also, the average retransmission count is estimated by block 120. The details of block 120 are shown in FIG. 6.

If the serial number of a data packet is the same as the serial number of the previous data packet, a retransmission has occurred. The repetitive gathering of the sequence number indicates the maximum number of retransmissions.

FIG. 6 is a flow chart depicting obtaining bandwidth estimations from other system nodes in accordance with various embodiments of the present invention. The flowchart of FIG. 6 depicts the details for bandwidth estimation and average number of retransmissions. The method of FIG. 6 is started, and block 140 is entered. The bandwidth on wireless link 21 between access point 20 and multimedia node 30 is estimated to be the sum of packet lengths divided by the sum of the number of packets. See equation below.
BANDWIDTH=Sum of the data packet lengths/Sum of the number of data packets
Block 142 gives the average number of retransmissions as the sum of the retransmissions divided by the sum of the number of data packets. See equation below.
Average # of retransmissions=Sum of # of retransmissions/Sum of the # of data packets

Block 144 then estimates the number of retransmissions per packet to be the maximum retransmission count.

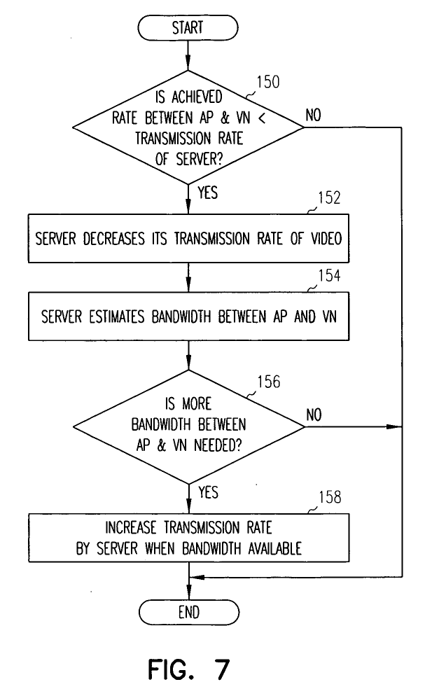

Returning to FIG. 4, processor 60 then adjusts the rate of data packet transmission of server 10 based upon the estimated quality of service parameters provided by analyzer 55, block 122. The details of this trans-rate adjustment are shown in FIG. 7.

FIG. 7 is a flow chart depicting trans-rating data in accordance with various embodiments of the present invention. This flowchart depicts the trans-rate adjustment method for transmitting the streaming data packets of server 10 to access point 20. The method of FIG. 7 is started and block 150 is entered. Block 150 determines whether the achieved rate between the access point 20 and multimedia node 30 is less than the current transmission rate of server 10. If not, block 150 transfers control to end the process via the NO path.

If so, block 150 transfers control to block 152 via the YES path, since the achieved rate is less than the current transmission rate of server 10. Server 10 decreases its data packet transmission rate for the data packets to a level approximately equal to the achieved transmission rate of access point 20 on wireless link 21, block 152. Multimedia server 10 then estimates a bandwidth between the access point 20 and multimedia node 30, block 154.

Block 156 determines whether more bandwidth on wireless link 21 is required. If not, block 156 transfers control to end the process via the NO path. If so, block 156 transfers control to block 158 via the YES path.

The method then increases the data packet transmission rate of server 10 when the bandwidth is available, block 158. That is, the transmission rate of server 10 is increased when the transmission rate on link 21 is substantially less than the rate server 10 is presently transmitting data. In addition, such bandwidth must be available through access point 20 and link 21. The process is then ended. Returning to FIG. 4, the process is then ended.

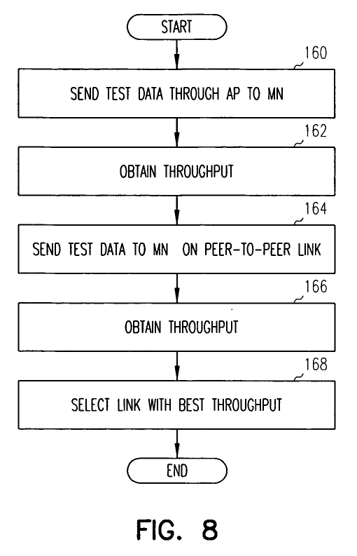

FIG. 8 is a flow chart of an alternate route or link selection method in accordance with various embodiments of the present invention. FIGS. 1 and 2 are to be taken along with FIG. 8 for an explanation of FIG. 8. The alternate link method is started and block 160 is entered. Multimedia server 10 may send a test message via link 11 or 12, to access point 20, via link 21 to multimedia node 30, block 160. This test message may be for the purpose of determining throughput of links 11, 12 and 21. The throughput of this link to multimedia node is obtained and stored, block 162.

Then multimedia server 10 may send a test message via peer-to peer link 31, block 164. The test message is again for the purpose of measuring throughput of the peer-to-peer link 31. Multimedia server 10 obtains the throughput result for the peer-to-peer link transmission.

A comparison of the throughputs is made. The link with the best throughput is selected for transmission of the multimedia data, block 168. That is either link 11, through access point 20, via link 21 or link 31 is selected for the transmission. The method is then ended.

As can be determined from the above explanation, the above-described method and apparatus for trans-rate adjustment may broaden the applicability of servers and provide a better multimedia product of wideband information. In addition, the various embodiments of the present invention may provide for simplicity and increased bandwidth of access points when used with a streaming multimedia server embodying the various embodiments of the present invention.

Additional traffic arriving at or leaving other nodes in the network may be monitored using this sniffing capability in the computing platform. The processing of such sniffed information to provide dynamic feedback to the application layer for bandwidth adaptation at the multimedia source provides for intelligent route selection.

Although illustrated in accordance with an example 802.11 implementation, the scope of the embodiments of the invention is not so limited, as it may well be implemented in WMAN (e.g., WiMAX), WPAN and or cellular telephony and/or data networks without deviating from the spirit and scope the disclosed embodiments.

Although some embodiments of the invention have been illustrated, and those forms described in detail, it will be readily apparent to those skilled in the art that various modifications may be made therein without departing from the spirit of these embodiments or from the scope of the appended claims.

1. A method comprising:
obtaining quality of service information by a device relating to a wireless link; and
adjusting a transmission rate of signals on a link from the device to a network node based upon the quality of service information, sniffed by the device, of the wireless link between the network node and a second node.

2. The method of claim 1 wherein, in obtaining, the device includes a server; and
wherein, in adjusting, the network node includes an access point.

3. The method of claim 1, wherein the signals comprise multimedia signals, the method further including:
re-transmitting the multimedia signals by the network node to the second node via the wireless link.

4. The method of claim 3, the sniffing including sniffing by the device in a promiscuous mode.

5. The method of claim 3, the adjusting including adjusting the transmission rate of the multimedia signals from the device to the network node further based upon quality of service information relating to a wireless link between the device and the network node.

6. The method of claim 1, the obtaining the quality of service information including promiscuously sniffing the wireless link to obtain data packets sent between the network node and the second node.

7. The method of claim 6, the sniffing including filtering the data packets to obtain the data packets.

8. The method of claim 7, wherein the obtaining the quality of service information includes using a physical layer header to obtain a first quality of service information comprising a data transfer rate of data packets between the network node and the second node.

9. The method of claim 8, the obtaining the quality of service information including using a physical layer header to obtain a second quality of service information comprising a number of bytes per data packet sent between the network node and the node, the using the physical layer header including:
obtaining a total length of each packet sent between the network node and the second node; and
subtracting a fixed length of the physical layer header.

10. The method of claim 9, the obtaining the quality of service information further including using a media access control address and a packet sequence number to obtain a third quality of service information comprising a number of re-transmissions of the data packets between the network node and the second node.

11. The method of claim 10, further including using the first quality of service information, the second quality of service information and the third quality of service information to provide a fourth quality of service information comprising a bandwidth estimate between the network node and the second node, and to provide a fifth quality of service information comprising an average re-transmission count of the data packets sent between the network node and the second node.

12. The method of claim 11, the adjusting including:
determining if a transmission rate of the wireless link is less than a current transmission rate of the device;
decreasing the current transmission rate of the device, if the transmission rate of the wireless link is less than the current transmission rate;
determining if greater bandwidth of the wireless link is required using the fourth quality of service information; and
increasing the current transmission rate when more bandwidth is available, if greater bandwidth is required.

13. A device comprising:
a server to couple to an access point, the server to transmit data packets to the access point;
a packet data sniffer to couple to a node via a first wireless link to obtain quality of service information relating to a second wireless link coupling the access point to the node, the second wireless link to transmit the data packets from the access point to the node; and
a processor coupled to the packet data sniffer to adjust a data transmission rate of the data packets from the server to the access point based on the quality of service information.

14. The device as claimed in claim 13, the data packets including multimedia signals.

15. The device as claimed in claim 13, wherein the server is to couple to the access point via a third wireless link.

16. The device as claimed in claim 13, further including a filter coupled to the packet data sniffer, the filter to obtain the data packets transmitted on the second wireless link.

17. The device as claimed in claim 13, further including a data decoder to obtain a data transmission rate and a data packet length from the data packets transmitted on the second wireless link.

18. The device as claimed in claim 13, further including an analyzer coupled to the data decoder, the analyzer to estimate a number of re-transmissions of the data packets on the second wireless link.

19. The device as claimed in claim 13, wherein the device comprises a semiconductor chip or semiconductor chip set.

20. The device as claimed in claim 19, wherein the device comprises part of a network interface card.

21. A machine-accessible medium having associated instructions, wherein the instructions, when accessed, result in a machine performing:
transmitting data packets of multimedia signals from a server to an access point;
promiscuously sniffing by the server a first wireless link to obtain quality of service information of the first wireless link; and
adjusting a transmission rate of the data packets of the multimedia signals from the server to the access point based upon the quality of service information relating to the first wireless link.

22. The machine-accessible medium of claim 21 wherein, in adjusting, the transmission rate of multimedia signals from the server to the access point is further based upon a quality of service information relating to a second wireless link between the server and the access point.

23. The machine-accessible medium of claim 21, wherein the instructions, when accessed, further result in the machine performing:
obtaining the quality of service information from a physical layer header of the data packets to obtain a data transfer rate on the first wireless link.

24. The machine-accessible medium of claim 22, wherein the instructions, when accessed, further result in the machine performing:
using a media access control address and a packet sequence number of the data packets to determine a number of re-transmissions on the first wireless link.

25. The machine-accessible medium of claim 22, wherein, in adjusting, a current transmission rate on the second wireless link is decreased, if the transmission rate of the data packets on the first wireless link is less than the current transmission rate.

26. The machine-accessible medium of claim 21, wherein there is further included selecting by the server an alternate peer-to-peer link for transmitting the multimedia signals.

27. A system comprising:
a server coupled to an access point to provide data packets through the access point to a node via a wireless link;
the server including:
a data packet sniffer to obtain quality of service information of the wireless link for the data packets transmitted between the access point and the node;
a processor to adjust a transmission rate of the data packets of the wireless link based upon the quality of service information; and
a substantially omni-directional antenna to couple the server to the wireless link.

28. The system as claimed in claim 27, the coupling of the server to the access point including a wireless link.

29. The system as claimed in claim 27, the server comprising a streaming multimedia server.

30. The system as claimed in claim 27, the node comprising a video player
